(19) United States
(12) Patent Application Publication
(10) Pub. No.: US 2015/0172734 A1
(43) Pub. Date: Jun. 18, 2015

(54) MULTI-ANGLE VIEW PROCESSING APPARATUS

(71) Applicant: Electronics and Telecommunications Research Institute, Daejeon-si (KR)

(72) Inventors: Tae-Jung KIM, Daejeon-si (KR); Ju-Il JEON, Cheongju-si (KR); Chang-Ki KIM, Daejeon-si (KR); Jae-Ho KIM, Nonsan-si (KR); Jeong-Ju YOO, Daejeon-si (KR); Jin-Woo HONG, Daejeon-si (KR)

(73) Assignee: Electronics and Telecommunications Research Institute, Daejeon-si (KR)

(21) Appl. No.: 14/253,175

(22) Filed: Apr. 15, 2014

(30) Foreign Application Priority Data
Dec. 18, 2013 (KR) 10-2013-0158617

(51) Int. Cl. H04N 21/2665; H04N 21/435; H04N 21/234; H04N 21/643; H04N 13/00; H04N 21/426; H04N 21/44

(52) U.S. Cl. CPC H04N 21/2665; H04N 21/42607; H04N 21/435; H04N 21/44016; H04N 21/64322; H04N 13/0048; H04N 13/0051; H04N 13/0066; H04N 21/23424

(57) ABSTRACT

In a multi-angle view processing apparatus, main-view data and at least one multi-angle view datum are received and processed through via one identical apparatus, and the main-view data and the at least one multi-angle view datum are separated into main images and sub images to be separately provided to different apparatuses, and as a result, seamless multi-angle view images selected by a user may be viewed with optimal resolution.

### CROSS-REFERENCE TO RELATED APPLICATION

This application claims priority from Korean Patent Application No. 10-2013-0158617, filed on Dec. 18, 2013, in the Korean Intellectual Property Office, the entire disclosure of which is incorporated herein by reference for all purposes.

### BACKGROUND

1. Field

The following description relates to a broadcast processing technology, and more particularly to a multi-angle view processing apparatus.

2. Description of Related Art

TV broadcast programs provide viewers with images through a channel, in which sports, music and entertainment programs, etc., are produced with various cameras positioned at multiple angles, so that scenes filmed from different angles may be provided to viewers. However, only the scenes selected by broadcasting stations are provided to viewers among many scenes produced, such that viewers sometimes may not see scenes from desired angles.

In order to solve this problem, as suggested by Korean Patent Publication No. 10-2012-0133550, a multi-angle broadcast service is provided in Internet Protocol (IP) TV and the like, in which images captured with multiple cameras are transmitted via different channels, and viewers may select to view desired images.

However, a conventional multi-angle service is merely a technology for delivering images already produced, and the service provides highly individualized content, as the service is provided to one terminal via one network. In addition, the jitter period of one second during screen change causes breaks in images and sounds.

In order to solve these problems, the inventors' of the present disclosure have studied a technology to provide main images of a broadcast program through a main-view display device, such as smart TVs, so that a whole family may enjoy the program, and to provide multi-angle views through a multi-angle view display device, such as smartphones, so that users may view desired multi-angle view images without image breaks.

### SUMMARY

Provided is a multi-angle view processing apparatus, in which main-view data and at least one multi-angle view datum are received and processed through one identical apparatus, and the main-view data and the at least one multi-angle view datum are provided separately to different apparatuses, so that a user may see desired multi-angle view images without image breaks.

According to an exemplary embodiment, there is disclosed a multi-angle view processing apparatus, which includes: a main-view data receiver configured to receive main-view data of broadcast content through a broadcast network; a multi-angle view data receiver configured to receive at least one multi-angle view datum of the broadcast content through Internet; a multi-decoder configured to decode the main-view data and the at least one multi-angle view datum received by the main-view data receiver and the multi-angle view data receiver, respectively; and a multi-renderer configured to perform rendering of the main-view data and the at least one multi-angle view datum decoded by the multi-decoder to separate the main-view data and the at least one multi-angle view datum into main images and sub images, and to reproduce the main images and the sub images.

The main-view data receiver may receive service metadata in which information associated with a multi-angle view service and synchronization is recorded.

The service metadata may include: information about a uniform resource locator (URL) of a Metadata Point Descriptor (MPD) that indicates an MPD file storage location of the at least one multi-angle view datum; synchronization information for synchronizing the main-view data with the at least one multi-angle view datum; and multi-angle view information that indicates multi-angle view numbers and respective multi-angle view names.

The synchronization information may be time estimation synchronization information based on program clock reference (PCR).

The synchronization information may be synchronization information based on a frame number.

The service metadata may be included in a packetized elementary stream (PES) packet of a main-view data frame of a digital broadcast specification.

The main-view data receiver may extract the MPD URL information from the service metadata, and the extracted MPD URL information may be provided to the multi-angle view data receiver.

The multi-angle view data receiver may include: an MPD controller configured to receive MPD URL information from the main-view data receiver, to send a request for an MPD file to at least one MPD URL included in the received MPD URL information to receive the requested MPD file, and to interpret the at least one received MPD file to obtain a storage location of the at least one multi-angle view datum; and a dynamic adaptive streaming over HTTP (DASH) client module configured to include at least one segment receiver that receives multi-angle view data from the storage location of the at least one multi-angle view datum, which is obtained by the MPD controller.

For multi-angle views selected by a user device, the DASH client module may use any one segment receiver to receive multi-angle view data with optimal resolution, and for other multi-angle views, the DASH client module may use other segment receivers to receive multi-angle view data with the lowest resolution.

The multi-angle view data storage location may be a specific URL of a web server that provides a multi-angle view service.

Each of the segment receivers may deliver elementary stream (ES) packets to the multi-decoder by de-muxing transport stream (TS) packets of multi-angle view data frames of a digital broadcast specification.

The multi-renderer may use a system clock of the multi-decoder to reproduce the multi-angle view data at the same time as the PCR, which is a reference clock, of the multi-angle view data.

The multi-renderer may reproduce the multi-angle view data with a multi-angle view frame number, which is a same number as a main view frame number.

### BRIEF DESCRIPTION OF THE DRAWINGS

FIG. 1 is a block diagram illustrating an example of a broadcast system to which a multi-angle view processing apparatus is applied according to an exemplary embodiment.

FIG. 2 is a block diagram illustrating an example of a multi-angle view processing apparatus according to an exemplary embodiment.

FIG. 3 is a block diagram illustrating an example of a multi-angle view data receiver of a multi-angle view processing apparatus according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

Hereinafter, the multi-angle view processing apparatus will be described in detail with reference to the accompanying drawings. The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

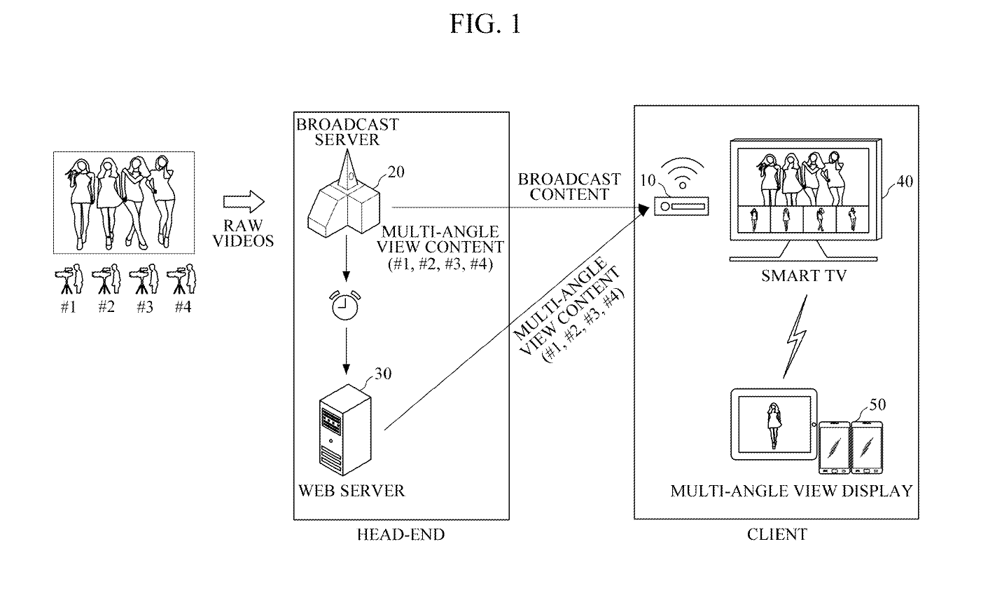

FIG. 1 is a block diagram illustrating an example of a broadcast system to which a multi-angle view processing apparatus is applied according to an exemplary embodiment. As illustrated in FIG. 1, the multi-angle view processing apparatus may be embodied in a set-top box 10, or in a smart device (not shown) that performs a similar function.

The multi-angle view processing apparatus 100 receives, via a broadcast network, main-view data provided by a broadcast server 20, and receives, via the Internet, at least one multi-angle view datum from a web server 30 that provides a multi-angle view service. Then, decoding and rendering of the main-view data and at least one multi-angle view datum are performed so that the data are separated into main images and sub images, and each of the datum is provided to different devices, thereby enabling those images to be reproduced seamlessly.

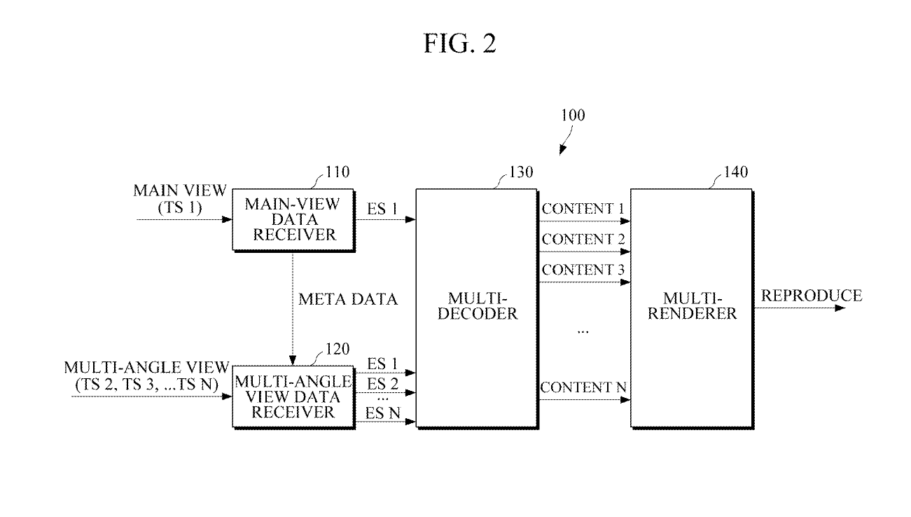

FIG. 2 is a block diagram illustrating an example of a multi-angle view processing apparatus according to an exemplary embodiment. As illustrated in FIG. 2, the multi-angle view processing apparatus 100 includes a main-view data receiver 110, a multi-angle view data receiver 120, a multi-decoder 130, and a multi-renderer 140.

The main-view data receiver 110 receives main-view data of broadcast content via a broadcast network. In this case, the main-view data receiver 100 may be configured to receive service metadata in which information associated with a multi-angle view service and synchronization is recorded.

The service metadata may be included in a packetized elementary stream (PES) packet with a main-view data frame of a digital broadcast specification, and may be received by the main-view data receiver 110.

For example, the service metadata may include: MPD URL information that indicates a metadata point descriptor (MPD) file storage location of at least one multi-angle view datum; synchronization information to synchronize main-view data with multi-angle view data; and multi-angle view information that indicates multi-angle view numbers and respective multi-angle view names.

The MPD file is a file in which information associated with multi-angle view data that includes multi-angle view data storage locations are recorded. For example, a multi-angle view data storage location may be a specific URL of a web server that provides a multi-angle view service.

Further, the synchronization information may be time estimation synchronization information based on program clock reference (PCR), or synchronization information based on a frame number. The PCR-based time estimation synchronization is a time-based synchronization method using a system clock, and the frame number based synchronization is a data-based synchronization method using an order of data frames received.

The number of multi-angle views and the respective multi-angle view names are information assigned individually to each multi-angle view to identify the multi-angle views, and the multi-angle view numbers are matched with the respective multi-angle view names.

The main-view data receiver 110 may be configured to extract MPD URL information from the service metadata, and the extracted MPD URL information may be provided to the multi-angle view data receiver 120.

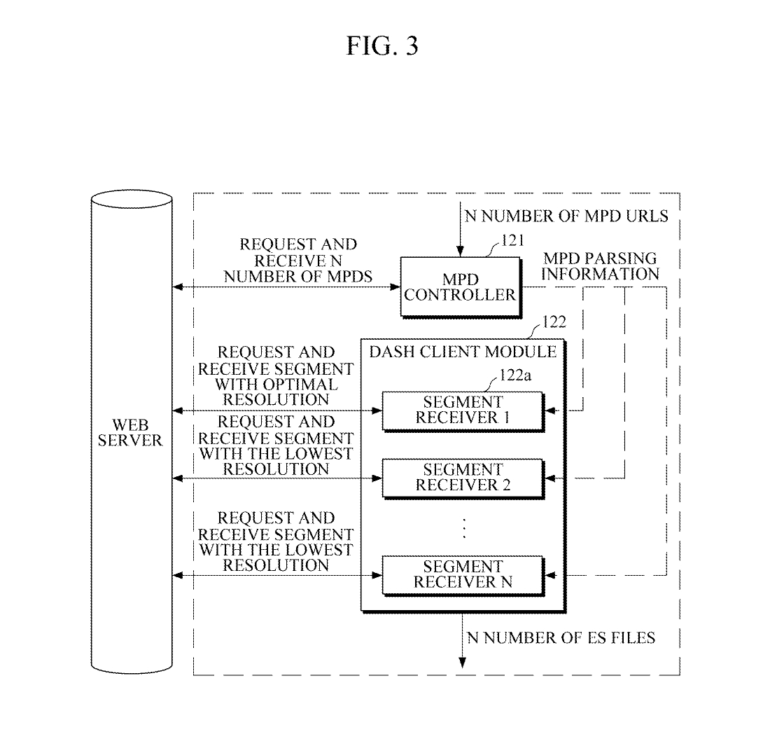

The multi-angle view data receiver 120 receives at least one multi-angle view datum of broadcast content via the Internet. For example, the multi-angle view data receiver 120 may be implemented as illustrated in FIG. 3.

FIG. 3 is a block diagram illustrating an example of a multi-angle view data receiver of a multi-angle view processing apparatus according to an exemplary embodiment. Referring to FIG. 3, the multi-angle view data receiver 120 includes an MPD controller 121, a dynamic adaptive streaming over HTTP (DASH) client module 122.

The MPD controller 121 receives MPD URL information from the main-view data receiver 110, sends a request for an MPD file to at least one MPD URL included in the received MPD URL information to receive the requested MPD file, and interprets the at least one received MPD file to obtain a storage location of the at least one multi-angle view datum.

The DASH client module 122 includes at least one segment receiver 122a, and each segment receiver 122a receives multi-angle view data from the storage location of the at least one multi-angle view datum, which is obtained by the MPD controller 121. The multi-angle view data may be identified by multi-angle view numbers and the respective multi-angle view names.

For multi-angle views selected by a user device that reproduces multi-angle views, such as a smartphone, etc., the DASH client module 122 receives multi-angle view data with optimal resolution using any one segment receiver, and for other multi-angle views, the DASH client module 122 receives multi-angle view data with the lowest resolution using other segment receivers. As a result, multi-angle view data may be received adaptively to channels, such that resource allocation for receiving multi-angle view data may be minimized, enabling a seamless service.

Each of the segment receivers 122a delivers ES packets to the multi-decoder 130 by de-muxing TS packets of multi-angle view data frames of a digital broadcast specification.

The multi-decoder 130 decodes main view data and at least one multi-angle view datum, which are received from the main-view data receiver 110 and the multi-angle view data receiver, respectively.

A broadcast server that provides a main-view service, and a web server that provides a multi-angle view service, respectively encode main view data and at least one multi-angle view datum, and the encoded main view data and at least one multi-angle view datum are provided to the multi-angle view processing apparatus 100 via a broadcast network and the Internet, respectively. Then, the multi-angle view processing apparatus 100 decodes, via the multi-decoder 130, the encoded main-view data and at least one multi-angle view data received.

The multi-renderer 140 performs rendering of the main view data and the at least one multi-angle view datum decoded via the multi-decoder 130, and separates the data into main images and sub images to reproduce the images. The main images and the sub images rendered by the multi-renderer 140 are provided respectively to a main-view display device, such as a smart TV that reproduces main images, and to a multi-angle view display device, such as a smartphone that reproduces sub images.

The multi-renderer 140 uses a system clock of the multi-decoder 130 to reproduce multi-angle view data through time estimation synchronization based on PCR at the same time as the PCR, which is a reference clock, of the multi-angle view data.

Alternatively, the multi-renderer 140 may reproduce, through synchronization based on a frame number, multi-angle view data with a multi-angle view frame number that is the same number as a main-view frame number.

As described above, main-view data and at least one multi-angle view datum are received and processed via one identical device, and the main view data and at least one multi-angle view datum are separated into main images and sub images to be separately provided to different devices, so that a user may select multi-angle view images with optimal resolution to be viewed seamlessly.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multi-angle view processing apparatus, comprising:
a main-view data receiver configured to receive main-view data of broadcast content through a broadcast network;
a multi-angle view data receiver configured to receive at least one multi-angle view datum of the broadcast content through Internet;
a multi-decoder configured to decode the main-view data and the at least one multi-angle view datum received by the main-view data receiver and the multi-angle view data receiver, respectively; and
a multi-renderer configured to perform rendering of the main-view data and the at least one multi-angle view datum decoded by the multi-decoder to separate the main-view data and the at least one multi-angle view datum into main images and sub images, and to reproduce the main images and the sub images.

2. The apparatus of claim 1, wherein the main-view data receiver receives service metadata in which information associated with a multi-angle view service and synchronization is recorded.

3. The apparatus of claim 2, wherein the service metadata comprises:
information about a uniform resource locator (URL) of a Metadata Point Descriptor (MPD) that indicates an MPD file storage location of the at least one multi-angle view datum;
synchronization information for synchronizing the main view data with the at least one multi-angle view datum; and
multi-angle view information that indicates multi-angle view numbers and respective multi-angle view names.

4. The apparatus of claim 3, wherein the synchronization information is time estimation synchronization information based on program clock reference (PCR).

5. The apparatus of claim 3, wherein the synchronization information is synchronization information based on a frame number.

6. The apparatus of claim 2, wherein a packetized elementary stream (PES) packet of a main view data frame of a digital broadcast specification comprises the service metadata.

7. The apparatus of claim 3, wherein the main view data receiver extracts the MPD URL information from the service metadata, and the extracted MPD URL information is provided to the multi-angle view data receiver.

8. The apparatus of claim 7, wherein the multi-angle view data receiver comprises:
an MPD controller configured to receive the MPD URL information from the main-view data receiver, to send a request for an MPD file to at least one MPD URL included in the received MPD URL information to receive the requested MPD file, and to interpret the received at least one MPD file to obtain a storage location of the at least one multi-angle view datum; and
a dynamic adaptive streaming over HTTP (DASH) client module configured to comprise at least one segment receiver that receives multi-angle view data from the storage location of the at least one multi-angle view datum, which is obtained by the MPD controller.

9. The apparatus of claim 8, wherein for multi-angle views selected by a user device, the DASH client module uses any one segment receiver to receive multi-angle view data with optimal resolution, and for other multi-angle views, the DASH client module uses other segment receivers to receive multi-angle view data with the lowest resolution.

10. The apparatus of claim 8, wherein the multi-angle view data storage location is a specific URL of a web server that provides a multi-angle view service.

11. The apparatus of claim 8, wherein each of the segment receivers delivers elementary stream (ES) packets to the multi-decoder by de-muxing transport stream (TS) packets of multi-angle view data frames of a digital broadcast specification.

12. The apparatus of claim 4, wherein the multi-renderer uses a system clock of the multi-decoder to reproduce the multi-angle view data at the same time as the PCR, which is a reference clock, of the multi-angle view data.

13. The apparatus of claim 5, wherein the multi-renderer reproduces the multi-angle view data with a multi-angle view frame number, which is a same number as a main-view frame number.
